(19) United States
(12) Patent Application Publication
(10) Pub. No.: US 2023/0382033 A1
(43) Pub. Date: Nov. 30, 2023

(54) HEATING CYLINDER HEATER, INJECTION APPARATUS, AND INJECTION MOLDING MACHINE

(71) Applicant: THE JAPAN STEEL WORKS, LTD., Tokyo (JP)

(72) Inventors: Takuya YUFU, Tokyo (JP); Akihiro NAITO, Tokyo (JP); Yasutaka OTSUJI, Tokyo (JP)

(73) Assignee: THE JAPAN STEEL WORKS, LTD., Tokyo (JP)

(21) Appl. No.: 18/322,103

(22) Filed: May 23, 2023

(30) Foreign Application Priority Data
May 25, 2022 (JP) 2022-084919

(51) Int. Cl. B29C 45/74; B29C 45/80; B29C 35/08

(52) U.S. Cl. CPC B29C 45/74; B29C 45/80; B29C 35/0805; B29C 2045/2748

(57) ABSTRACT

A heating cylinder heater includes a plurality of infrared heaters disposed around a heating cylinder in a non-contact manner with respect to the heating cylinder, a heat insulating material provided outside the infrared heaters, and a cover configured to cover the heat insulating material. The cover has two or more opening portions, and a part or all of the two or more opening portions are each provided with an opening-closing device that is configured to open and close the corresponding opening portion.

### CROSS-REFERENCE TO RELATED APPLICATIONS

This application is based on and claims priority under 35 USC 119 from Japanese Patent Application No. 2022-084919 filed on May 25, 2022, the entire content of which is incorporated herein by reference.

### TECHNICAL FIELD

The present disclosure relates to a heating cylinder heater for heating a heating cylinder of an injection molding machine, an injection apparatus including a heating cylinder heater, and an injection molding machine.

### BACKGROUND

An injection molding machine includes an injection apparatus and a mold clamping device. The injection apparatus includes a heating cylinder and a screw placed in the heating cylinder. A band heater is provided in the heating cylinder. The heating cylinder is heated by the band heater, an injection material is supplied, and the screw is rotated. Then, the injection material is melted by heat generated by the band heater and shear heat generated by the rotation of the screw, and injection material is metered.

JPS59-184623U describes a heating cylinder heater including an infrared heater. The heating cylinder heater described in JPS59-184623U includes a plurality of infrared rays provided outside the heating cylinder in a non-contact manner, and a heat insulating material provided outside the infrared heater. When a current is supplied to the infrared heater, the heating cylinder is heated by the infrared rays.

### SUMMARY

Both the band heater and the heating cylinder heater described in JPS59-184623U are excellent because the heating cylinder can be appropriately heated. However, there is also a problem to be solved. In some cases, the heating cylinder may generate heat due to a shearing force generated in the injection material by rotating the screw and become higher in temperature than a target temperature depending on the position. In particular, the temperature is likely to rise at a center position of the heating cylinder. For example, when the heating cylinder is provided with the band heater, cold air can be blown from the outside of the band heater, but the heat insulating material provided on the band heater prevents efficient cooling. There is a problem that there is no unit for cooling the heating cylinder heater described in JPS59-184623U.

Illustrative aspects of the present disclosure provide a heating cylinder heater that can perform cooling appropriately.

Other problems and novel features will become apparent from description of the present description and the accompanying drawings.

According to one illustrative aspect of the present disclosure, a heating cylinder heater includes a plurality of infrared heaters disposed around a heating cylinder in a non-contact manner with respect to the heating cylinder, a heat insulating material provided outside the infrared heaters, and a cover configured to cover the heat insulating material. The cover has two or more opening portions, and a part or all of the two or more opening portions are each provided with an opening-closing device that is configured to open and close the opening portion.

According to the illustrative aspect of the present disclosure, a heating cylinder can be efficiently cooled.

### BRIEF DESCRIPTION OF DRAWINGS

FIG. 1 is a front view showing an injection molding machine according to the present illustrative embodiment.

FIG. 2 is a front view showing an injection apparatus including a heating cylinder heater according to the present illustrative embodiment.

FIG. 3 is a side sectional view showing the injection apparatus including the heating cylinder heater according to the present illustrative embodiment.

FIG. 4 is a side sectional view showing the injection apparatus including the heating cylinder heater according to the present illustrative embodiment.

FIG. 5A is a side sectional view showing an injection apparatus including a heating cylinder heater according to a second illustrative embodiment.

FIG. 5B is a side sectional view showing the injection apparatus including the heating cylinder heater according to the second illustrative embodiment.

FIG. 5C is a side sectional view showing an injection apparatus including a heating cylinder heater according to a third illustrative embodiment.

### DETAILED DESCRIPTION

Hereinafter, specific illustrative embodiments will be described in detail with reference to the drawings. The present disclosure is not limited to the following illustrative embodiments. In order to clarify the description, the following description and the drawings are simplified as appropriate. In the drawings, the same elements are denoted by the same reference numerals, and repeated description thereof is omitted as necessary. Further, hatching may be omitted so as not to complicate the drawings.

### {Injection Molding Machine}

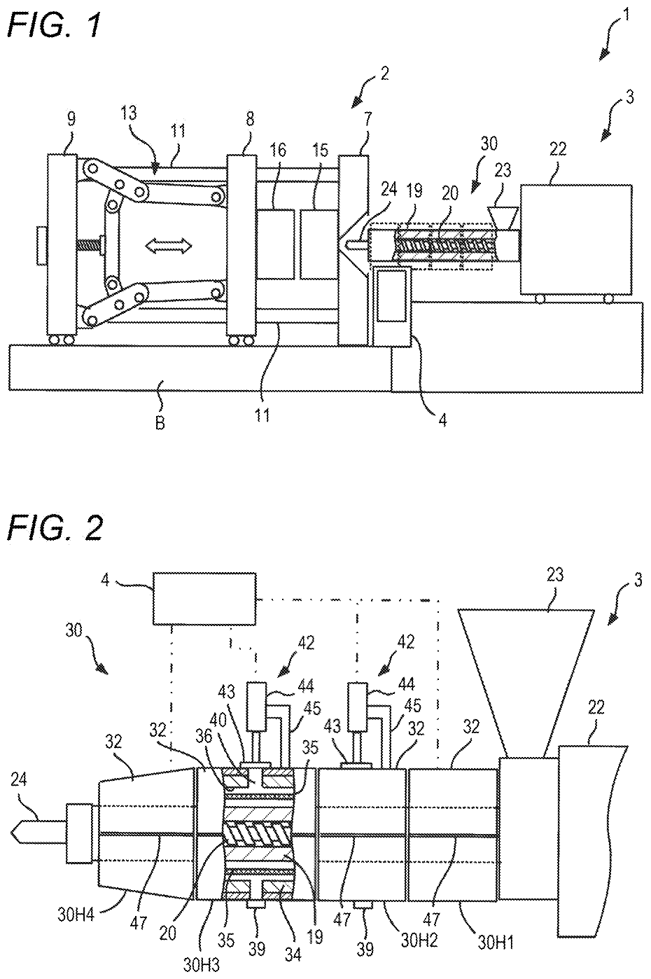

As shown in FIG. 1, an injection molding machine 1 according to the present illustrative embodiment includes a mold clamping device 2, an injection apparatus 3, and the like. The injection molding machine 1 includes a controller, that is, a control device 4. The mold clamping device 2, the injection apparatus 3, and the like are controlled by the control device 4. A heating cylinder heater 30, which will be described later, is also controlled by the control device 4. In FIG. 1, the heating cylinder heater 30 is indicated by a dotted line.

### {Mold Clamping Device}

The mold clamping device 2 includes a fixed plate 7 fixed to a bed B, a movable plate 8 slidably provided on the bed B, and a mold clamping housing 9. The fixed plate 7 and the mold clamping housing 9 are coupled to each other by a plurality of tie bars 11, 11, . . . . The movable plate 8 is slidable between the fixed plate 7 and the mold clamping housing 9. A mold clamping mechanism is provided between the mold clamping housing 9 and the movable plate 8, that is, in the present illustrative embodiment, a toggle mechanism 13 is provided. A mold 15 on a fixed side and a mold 16 on a movable side are provided on the fixed plate 7 and the movable plate 8, respectively. Therefore, the molds 15 and 16 are opened and closed when the toggle mechanism 13 is driven.

### {Injection Apparatus}

The injection apparatus 3 includes a heating cylinder 19, a screw 20 provided in the heating cylinder 19, and a screw driving device 22. The heating cylinder 19 is supported by the screw driving device 22. The screw 20 is driven by the screw driving device 22 in a rotational direction and an axial direction. The heating cylinder 19 is provided with a hopper 23 and an injection nozzle 24.

### {Heating Cylinder Heater}

The heating cylinder heater 30 according to the present illustrative embodiment will be described. As shown in FIG. 2, the heating cylinder heater 30 is provided on the heating cylinder 19. In the present illustrative embodiment, the heating cylinder heater 30 is configured by four heaters. That is, the heating cylinder 30 is configured by a first heating cylinder heater 30H1 close to the hopper 23, a second heating cylinder heater 30H2 on a downstream side of the first heating cylinder heater 30H1, a third heating cylinder heater 30H3 on the downstream side of the second heating cylinder heater 30H2, and a fourth heating cylinder heater 30H4 on the downstream side of the third heating cylinder heater 30H3 and close to the injection nozzle 24. The second and third heating cylinder heaters 30H2 and 30H3 have the same structure. Thus, the third heating cylinder heater 30H3 will be described first.

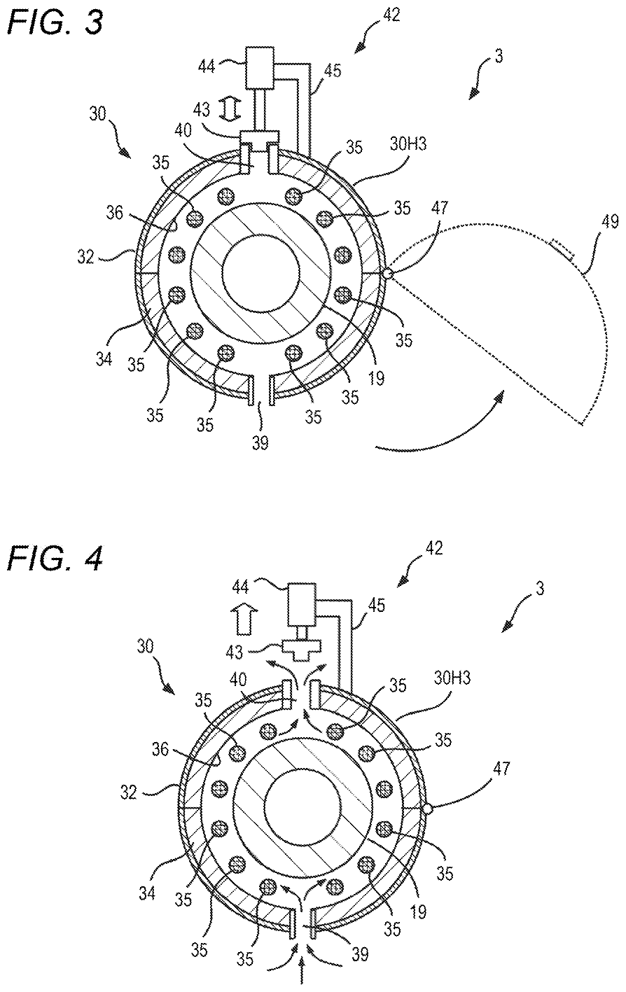

As shown in FIGS. 2 and 3, the third heating cylinder heater 30H3 includes a cylindrical cover 32, a heat insulating material 34 provided inside the cover 32, and a plurality of infrared heaters 35, 35, . . . disposed inside the heat insulating material 34. The infrared heaters 35, 35, . . . are disposed outside the heating cylinder 19 and are not in contact with the heating cylinder 19. Therefore, when the infrared heaters 35, 35, . . . are energized, infrared rays are emitted and the heating cylinder 19 can be heated. In the present illustrative embodiment, a reflection plate 36 is provided on an inner circumferential surface of the heat insulating material 34. The reflection plate 36 is not necessarily an essential component, but it is possible to efficiently heat the heating cylinder 19 by reflecting the infrared rays. Incidentally, instead of the reflection plate 36, a metal film may be formed on the inner circumferential surface of the heat insulating material 34 by vapor deposition or the like.

In the present illustrative embodiment, one opening portion 39 is formed at a lower part of the cover 32, and one opening portion 40 is formed at an upper part of the cover 32. The opening portions 39 and 40 penetrate the heat insulating material 34 and communicate with a space surrounded by the inside of the heat insulating material 34 and an outer circumferential surface of the heating cylinder 19. Of the opening portions 39 and 40, the opening portion 39 at the lower part is normally open, and the opening portion 40 at the upper part is provided with an opening-closing unit 42 configured to open and close the opening portion 40. The opening-closing unit 42 includes a lid 43 that closes the opening portion 40, a cylinder unit 44 configured to drive the lid 43, and a bracket 45 that supports the cylinder unit 44. The cylinder unit 44 is driven by the control device 4. When the cylinder unit 44 is driven, the opening portion 40 is opened and closed by the lid 43. The opening portions 39 and 40 and the opening-closing unit 42 serve as a cooling unit for cooling the heating cylinder 19.

In the present illustrative embodiment, as shown in FIG. 3, the cover 32 is split into two halves, an upper half and a lower half, which are connected to each other by a hinge 47. Therefore, when a fastener (not shown) is removed, the lower half of the cover 32 rotates about the hinge 47, and the cover 32 is opened as indicated by a dotted line 49. In this way, the third heating cylinder heater 30H3 can be removed from the heating cylinder 19.

As described above, since the second heating cylinder heater 30H2 is configured similarly to the third heating cylinder heater 30H3, the description thereof is omitted. The first heating cylinder heater 30H1 and the fourth heating cylinder heater 30H4 have a configuration similar to that of the third heating cylinder heater 30H3, but is partially different. Specifically, the opening portions 39 and 40 are not formed, and the opening-closing unit 42 is not provided. That is, the first heating cylinder heater 30H1 and the fourth heating cylinder heater 30H4 are not provided with the cooling unit for cooling the heating cylinder 19. A reason why the first heating cylinder heater 30H1 is not provided with the cooling unit is that a portion of the heating cylinder 19 near the hopper 23 is relatively easy to be cooled as heat is transferred to the screw driving device 22 by heat conduction. A reason why the fourth heating cylinder heater 30H4 is not provided with the cooling unit is that a tip of the heating cylinder 19 is exposed and is relatively easily cooled.

### {Operation}

The operation of the heating cylinder heater 30 according to the present illustrative embodiment will be described. When starting operation in the injection molding machine 1 (see FIG. 1), electric power is supplied to the heating cylinder heater 30 under the control of the control device 4. That is, the infrared heaters 35, 35, . . . in the first to fourth heating cylinder heaters 30H1, 30H2, . . . (see FIGS. 2 and 3) are energized. The infrared heaters 35, 35, . . . emit infrared rays to heat the heating cylinder 19. A temperature sensor (not shown) is embedded in the heating cylinder 19, and the control device 4 performs control so as to reach a target temperature. The mold clamping device 2 is driven to mold clamp the molds 15 and 16. The injection material is supplied from the hopper 23, and the screw 20 is rotated. Then, the injection material is melted and sent to the front of the heating cylinder 19. That is, the metering is performed. When the screw 20 is driven in the axial direction, the injection material is injected into the molds 15 and 16. That is, a molded object is molded.

The heating cylinder 19 generates heat by a shearing force acting on the injection material at the time of rotation of the screw 20. When a molding cycle is repeated, the heat generation may cause the heating cylinder 19 to exceed the target temperature depending on the position. The control device 4 drives the opening-closing unit 42 (see FIG. 3) of the heating cylinder heater 30. That is, the cylinder unit 44 is driven to open the lid 43. Then, as shown in FIG. 4, the opening portion 40 at the upper part is opened. An internal space surrounded by the outer circumferential surface of the heating cylinder 19 and the inner circumferential surface of the heat insulating material 34 is filled with high-temperature air. Since the high-temperature air has a low specific gravity, the high-temperature air flows out from the opening portion 40 at the upper part, and at the same time, cool air flows in from the opening portion 39 at the lower part. The air in the internal space is rapidly switched by such convection, and the heating cylinder 19 is cooled. When the heating cylinder 19 reaches the target temperature, the cylinder unit 44 is driven to close the lid 43.

In the heating cylinder heater 30 according to the present illustrative embodiment, the cover 32 is provided with the opening portions 39 and 40, and the opening-closing unit 42 is provided for the opening portion 40 at the upper part, so that the heating cylinder 19 can be rapidly cooled. Therefore, for example, it is possible to rapidly cool the heating cylinder 19 even in an operation of changing a type of the injection material, that is, changing a resin, changing a color, or the like, and thus the efficiency is good. Further, the cooling can be performed efficiently by utilizing convection of air, so that energy saving is achieved.

### Second Illustrative Embodiment

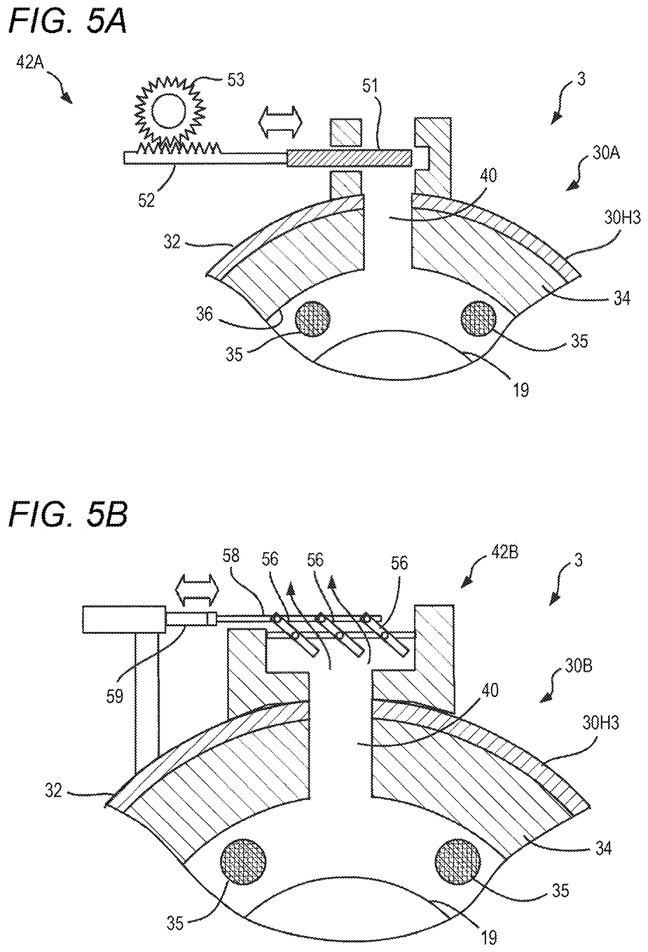

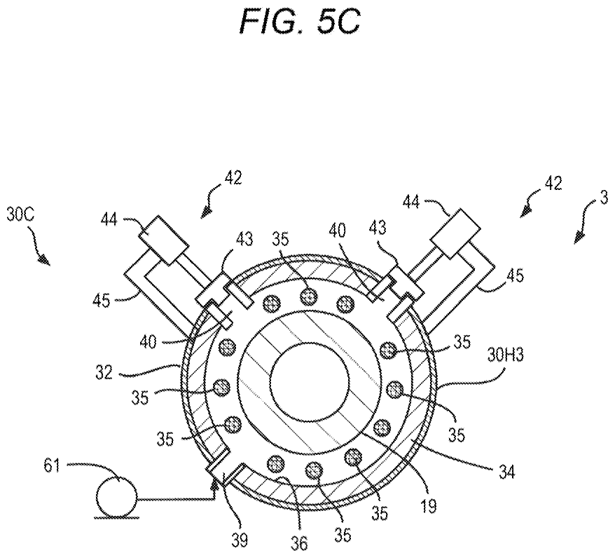

The present illustrative embodiment can be variously modified. FIG. 5A shows a part of a heating cylinder heater 30A according to a second illustrative embodiment. In this illustrative embodiment, an opening-closing unit 42A of the opening portion 40 is modified. The opening-closing unit 42A includes a valve body 51 that slides in a lateral direction, a rack 52 that drives the valve body 51, and a pinion 53. The pinion 53 is driven by a motor (not shown), and when the pinion 53 is rotated, the valve body 51 slides. In this illustrative embodiment, the valve body 51 can adjust an opening degree of the opening portion 40. Therefore, strength of cooling can be controlled by increasing the opening degree when rapid cooling is desired and by decreasing the opening degree when gentle cooling is desired.

FIG. 5B shows a part of a heating cylinder heater 30B according to a third illustrative embodiment. In this illustrative embodiment, an opening-closing unit 42B of the opening portion 40 is also modified. The opening-closing unit 42B includes a plurality of rotatable shutters 56, 56, . . . , a driving rod 58 for rotating the shutters 56, 56, . . . , and a cylinder unit 59 for driving the driving rod 58. By controlling the cylinder unit 59, a driving amount of the driving rod 58 can be adjusted, and rotation amounts of the shutters 56, 56, . . . can be adjusted. In this way, the opening degree of the opening portion 40 can be adjusted.

FIG. 5C shows a heating cylinder heater 30C according to a fourth illustrative embodiment. In this illustrative embodiment, two opening portions 40 and 40 are formed at the upper part of the cover 32, and are slightly lower than the uppermost part of the cover 32. The two opening portions 40 and 40 are provided with opening-closing units 42 and 42 respectively similar to the heating cylinder heater 30 (see FIG. 3) according to the first illustrative embodiment. The opening portion 39 at the lower part is opened slightly above the lowermost part of the cover 32, and is connected to a blower 61. In the heating cylinder heater 30C according to the fourth illustrative embodiment, during cooling, only one of the two opening-closing units 42 and 42 may be driven to open and close one of the opening portions 40 and 40, or both may be driven to open both. As a result, the strength of cooling can be adjusted. Further, when the strength of the cooling is desired to be further increased, compressed air is forcibly supplied by the blower 61. The compressed air can be supplied not by the blower 61 but by other units such as a compressed air source.

### OTHER MODIFICATIONS

Various other modifications can be made for the present illustrative embodiment. For example, in the first illustrative embodiment, the second heating cylinder heater 30H2 and the third heating cylinder heater 30H3 are described such that the opening portions 39 and 39 at the lower part of the covers 32 and 32 are always opened. However, an opening-closing unit may be provided in these opening portions 39 and 39. When cooling is required, the opening-closing unit may be driven to open the opening portions 39 and 39.

Other modifications are also possible. The heating cylinder heater 30 is described to include the first to fourth heating cylinder heaters 30H1, 30H2, . . . . Alternatively, the number of the heating cylinder heaters may be three or less or five or more. In the present illustrative embodiment, it has been described that the opening portions 39 and 40 are not opened in the first heating cylinder heater 30H1 and the fourth heating cylinder heater 30H4. However, the opening portions 39 and 40 may be formed in the first heating cylinder heater 30H1 and the fourth heating cylinder heater 30H4, and the opening-closing unit 42 of the opening portion 40 may be provided thereto.

Although the invention made by the present inventor is specifically described based on the illustrative embodiments, it is needless to say that the present invention is not limited to the illustrative embodiments described above, and various modifications can be made without departing from the scope of the invention. A plurality of examples described above may be implemented in combination as appropriate.

What is claimed is:

1. A heating cylinder heater comprising:
a plurality of infrared heaters disposed around a heating cylinder in a non-contact manner with respect to the heating cylinder;
a heat insulating material provided outside the infrared heaters; and
a cover configured to cover the heat insulating material,
wherein the cover has two or more opening portions, and a part or all of the two or more opening portions are each provided with an opening-closing device that is configured to open and close the corresponding opening portion.

2. The heating cylinder heater according to claim 1,
wherein one or more opening portions are formed at a lower part of the cover,
wherein another one or more opening portions are formed at an upper part of the cover, and
wherein the opening-closing device is provided for at least one of the opening portions formed at the upper part.

3. The heating cylinder heater according to claim 1,
wherein the opening-closing device comprises an actuator, and
wherein at least one of the opening portions is opened and closed by driving the actuator.

4. The heating cylinder heater according to claim 1, wherein the opening-closing device is configured to adjust an opening degree of the opening portion.

5. The heating cylinder heater according to claim 1 configured to supply compressed air to the opening portion.

6. An injection apparatus comprising:
a heating cylinder;
a screw provided in the heating cylinder; and
a heating cylinder heater provided on the heating cylinder, the heating cylinder heater comprising:
a plurality of infrared heaters disposed around the heating cylinder in a non-contact manner with respect to the heating cylinder;
a heat insulating material provided outside the infrared heaters; and
a cover configured to cover the heat insulating material, and
wherein the cover has two or more opening portions, and a part or all of the two or more opening portions are each provided with an opening-closing device that is configured to open and close the opening portion.

7. The injection apparatus according to claim 6,
wherein one or more opening portions are formed at a lower part of the cover,
wherein another one or more opening portions are formed at an upper part of the cover, and
wherein the opening-closing device is provided for at least one of the opening portions formed at the upper part.

8. The injection apparatus according to claim 6, further comprising:
a control device,
wherein the opening-closing device comprises an actuator, and
wherein the control device is configured to control the actuator.

9. The injection apparatus according to claim 6, wherein the opening-closing device is configured to adjust an opening degree of the opening portion.

10. The injection apparatus according to claim 6 configured to supply compressed air to the opening portion.

11. The injection apparatus according to claim 6,
wherein the heating cylinder is divided into a plurality of zones, and
wherein a plurality of the heating cylinder heaters are provided corresponding to the respective zones.

12. The injection apparatus according to claim 6,
wherein the heating cylinder is divided into a plurality of zones,
wherein the heating cylinder heater is provided corresponding to one or more specific zones, and
wherein a non-opening heating cylinder heater without the opening portion is provided in other zone other than the one or more specific zones.

13. An injection molding machine comprising:
an injection apparatus; and
a mold clamping device; and
an injection apparatus comprising:
a heating cylinder;
a screw provided in the heating cylinder; and
a heating cylinder heater provided on the heating cylinder, the heating cylinder heater comprising:
a plurality of infrared heaters disposed around the heating cylinder in a non-contact manner with respect to the heating cylinder;
a heat insulating material provided outside the infrared heaters; and
a cover configured to cover the heat insulating material, and
wherein the cover has two or more opening portions, and a part or all of the two or more opening portions are each provided with an opening-closing device that is configured to open and close the opening portion.

14. The injection molding machine according to claim 13,
wherein one or more opening portions are formed at a lower part of the cover,
wherein another one or more opening portions are formed at an upper part of the cover, and
wherein the opening-closing device is provided for at least one of the opening portions formed at the upper part.

15. The injection molding machine according to claim 13, further comprising:
a control device,
wherein the opening-closing device comprises an actuator, and
wherein the control device is configured to control the actuator.

16. The injection molding machine according to claim 15, wherein the control device is configured to control the actuator of the opening-closing device to adjust an opening degree of at least one of the opening portions.

17. The injection apparatus according to claim 8, wherein the control device is configured to control the actuator of the opening-closing device to adjust an opening degree of at least one of the opening portions.
